(19) United States
(12) Patent Application Publication
(10) Pub. No.: US 2023/0050299 A1
(43) Pub. Date: Feb. 16, 2023

(54) MULTI-CABLE ACTUATION FOR ENERGY-EFFICIENT TENSEGRITY ROBOTS

(71) Applicant: The Regents of the University of California, Oakland, CA (US)

(72) Inventors: Alice M. AGOGINO, Oakland, CA (US); Brian M. CERA, Oakland, CA (US); Anthony Allan THOMPSON, Oakland, CA (US)

(73) Assignee: The Regents of the University of California, Oakland, CA (US)

(21) Appl. No.: 17/791,172

(22) PCT Filed: Jan. 7, 2021
(86) PCT No.: PCT/US2021/012528

§ 371 Date: Jul. 6, 2022

Related U.S. Application Data
(60) Provisional application No. 62/957,923, filed on Jan. 7, 2020.

(51) Int. Cl. B62D 57/02; B25J 9/10

(52) U.S. Cl. CPC B62D 57/02; B25J 9/1045; B25J 9/1075; E04B 2001/1996

(57) ABSTRACT

A tensegrity robot includes multiple tensile members connected to multiple structural members to form a spatially defined structure. Each structural member is connected to one or more other structural members by tensile members therebetween. The robot further includes multiple actuators operatively connected to the tensile members and the structural members, and multiple controllers configured to communicate with each of the actuators. The controllers direct control of at least one of tension or length of the tensile members by the actuators to cause a change in at least one of the size, shape or center of gravity of the spatially defined structure to effect robotic actions. At least two tensile members are connected to an actuator such that at least one of tension or length in both of the tensile members are changed in coordination by the actuator.

### CROSS-REFERENCE OF RELATED APPLICATION

This application claims priority to U.S. Provisional Application No. 62/957,923, filed Jan. 7, 2020, the entire contents of which are hereby incorporated by reference.

This invention was made with government support under grant number NNX15AD74G awarded by the National Aeronautics and Space Administration. The government has certain rights in the invention.

### BACKGROUND

### 1. Technical Field

Some embodiments relate to robotics, and more particularly to tensegrity robotic systems, methods and components.

### 2. Discussion of Related Art

Prior work done at UC Berkeley Emerging Space Tensegrities (BEST) Lab demonstrated that tensile-integrity systems (called “tensegrity” systems) are useful for a wide range of applications, including space exploration and disaster robotics in various ways. For example, spherical tensegrity structures can be actuated to roll along even or uneven ground by manipulating the tension distribution in their series-elastic structure to achieve a shape-shifting behavior.

Many use-cases for tensegrity robots involve impact to the structures. Tensegrity structures used in disaster situations and in future space exploration often must withstand drops from high altitudes. This requirement necessitates that such tensegrity robots have a high overall structural stiffness to safely withstand large external forces from impact. However, achieving practical motion or movement with compliant spherical tensegrities is a significant challenge due to the high stiffness and large internal forces throughout the robot and the resulting high-power actuation required to manipulate the robot's overall shape. Additionally, the compliance and many degrees of freedom that enable tensegrity robots' unique adaptability has, in the past, also necessitated multiple, expensive, and heavy actuators to achieve dynamic movement.

Motion and mobility with tensegrity systems is conventionally achieved by actuating individual cables using motor actuators. Extension and retraction of an individual cable is most often driven by spooling or unspooling a series-elastic element using the motor output shaft. Motors have been used in prior work to control each individual cable that constitutes the outer structure of a tensegrity. In prior embodiments, fully actuated spherical tensegrity systems traditionally used 24 motors to achieve practical and efficient rolling locomotion with respect to both speed and directional control. There thus remains a need for improved tensegrity robotic systems.

### SUMMARY

A tensegrity robot according to some embodiments of the invention includes multiple tensile members connected to multiple structural members to form a spatially defined structure. Each structural member is connected to one or more other structural members by tensile members therebetween. The tensegrity robot further includes multiple actuators operatively connected to the tensile members and the structural members, and multiple controllers configured to communicate with each of the actuators. The controllers direct control of at least one of tension or length of the tensile members by the actuators to cause a change in at least one of the size, shape or center of gravity of the spatially defined structure to effect robotic actions. At least two tensile members are connected to an actuator such that at least one of tension or length in both of the tensile members are changed in coordination by the actuator.

A method for computer control of a tensegrity robot according to some embodiments of the invention. The method receives, by a computer, data from multiple sensors from said tensegrity robot, the data including at least one of tension or length of multiple tensile members connected to multiple structural members to form a spatially defined structure such that each structural member is connected to one or more other structural members by one or more of the tensile members therebetween. The method computes, based on the received sensor data, a locomotion strategy for the tensegrity robot. The method directs, based on the locomotion strategy, at least one of tension or length of the tensile members by multiple actuators operatively connected to the tensile members and the structural members, so as to cause at least one of a change in size, shape or center of gravity of the spatially defined structure to effect robotic actions. At least two tensile members are connected to one actuator such that at least one of tension or length in both of the at least two tensile members are changed in coordination by the one actuator in response to the directing.

A non-transitory machine-readable medium storing computer-executable code for computer control of a tensegrity robot according to some embodiments of the invention. When executed, the code configures a computer to receive data from multiple sensors from the tensegrity robot, the data including at least one of tension or length of multiple tensile members connected to multiple structural members to form a spatially defined structure such that each structural member is connected to one or more other structural members by one or more of the tensile members therebetween. When executed, the code further configures the computer to compute, based on the received data, a locomotion strategy for the tensegrity robot. When executed, the code further configures the computer to direct, based on the locomotion strategy, at least one of tension or length of the tensile members by multiple actuators operatively connected to the tensile members and the structural members, so as to cause at least one of a change in size, shape or center of gravity of the spatially defined structure to effect robotic actions. At least two tensile members are connected to one actuator such that at least one of tension or length in both of the at least two tensile members are changed in coordination by the one actuator in response to the directing.

### BRIEF DESCRIPTION OF THE DRAWINGS

FIG. 1 shows an embodiment of a rod used in the design of a tensegrity robot.

FIGS. 2A and 2B show embodiments using an actuator located in housing in the center of the robot.

FIG. 3A conceptually illustrates paired-cable actuation control of 24 cables using only 12 motors.

FIG. 3B shows the hardware design of an embodiment using a rod-located actuator.

FIG. 4 shows an embodiment for a six-rod spherical tensegrity.

FIG. 5 depicts the dynamic nature of changing cable lengths over time for a periodic rolling gait in some embodiments.

FIGS. 6A-6C illustrate an embodiment of a cable convention for a paired-cable actuation schema for the six-rod spherical design.

FIG. 7 shows a Hookean linear-elastic model between two-point masses, used in some embodiments to calculate forces due to cables on the rods.

FIG. 8 shows a comparison of average rolling speeds vs. overall stiffness and initial cable pretension, for some embodiments with a 24-motor scheme.

FIG. 9 shows footprint trails of a robot in embodiments for 24-motor, fully actuated, 12-motor paired-actuated, and 6-motor actuation policies.

FIG. 10 shows a plot of normalized average speeds of different embodiments in various directions, starting from an identical initial state, for a fully-actuated 24-motor scheme and a 12-motor paired-cable activation scheme.

FIG. 11 shows individual cable tensions and total tensions for an embodiment with 24-motor rolling locomotion.

FIG. 12 shows a MATLAB simulation of six-bar spherical tensegrity rolling using 24-cable actuation.

FIG. 13 conceptually illustrates a simulation framework using an object-oriented approach.

FIG. 14 shows different types of Class-1 spherical tensegrities.

FIG. 15 shows an example of a single symbolic equation of motion representing the acceleration of a single node.

FIG. 16 illustrates a visualization depicting Monte Carlo simulations of robot center-of-mass trajectory during bouncing.

FIG. 17 shows controlled cable rest lengths from a contextual neural network policy trained using imitation learning.

FIG. 18 shows rolling locomotion in a square trajectory controlled using a contextual policy trained through supervised learning.

FIG. 19 shows a comparison of rolling performance with/without state estimation and robust optimal motion planning.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed, and other methods developed without departing from the broad concepts of the current invention. All references cited anywhere in this specification, including the Background and Detailed Description sections, are incorporated by reference as if each had been individually incorporated.

Accordingly, some embodiments of the present invention relate to a novel improvement for the actuation of tensegrity robots. This new scheme uses software innovations and hardware designs that differ from previous schemes and designs employing a single motor to control each individual tension element. The new “Squishy Robotics” embodiments of the current invention advances the mobility of tensegrity robots by replacing single-cable actuation with multi-cable actuation.

Similar to the 24-motor actuation scheme, a 12-motor paired-cable actuation scheme also controls all 24 cables in a spherical tensegrity; however, for the 12-motor scheme, in some embodiments at least two cables are coupled by a single motor. For example, in one such multi-cable actuation scheme, a pair of cables meet at a single node—the retraction of one cable means the extension of the other cable in that pair. Thus, while all 24 cables are actuated, only 12 degrees of freedom exist in the system:

$$u = [ \begin{matrix}1 & 0 & 0 & 0 & 0 & 0 & 0 & 0 & 0 & 0 & 0 & 0 \\ 0 & 1 & 0 & 0 & 0 & 0 & 0 & 0 & 0 & 0 & 0 & 0 \\ 0 & 0 & 1 & 0 & 0 & 0 & 0 & 0 & 0 & 0 & 0 & 0 \\ 0 & 0 & - 1 & 0 & 0 & 0 & 0 & 0 & 0 & 0 & 0 & 0 \\ 0 & 0 & 0 & 1 & 0 & 0 & 0 & 0 & 0 & 0 & 0 & 0 \\ 0 & 0 & 0 & 0 & 1 & 0 & 0 & 0 & 0 & 0 & 0 & 0 \\ 0 & 0 & 0 & 0 & 0 & 1 & 0 & 0 & 0 & 0 & 0 & 0 \\ 0 & 0 & 0 & 0 & 0 & - 1 & 0 & 0 & 0 & 0 & 0 & 0 \\ 0 & 0 & 0 & - 1 & 0 & 0 & 0 & 0 & 0 & 0 & 0 & 0 \\ 0 & 0 & 0 & 0 & - 1 & 0 & 0 & 0 & 0 & 0 & 0 & 0 \\ 0 & 0 & 0 & 0 & 0 & 0 & 1 & 0 & 0 & 0 & 0 & 0 \\ 0 & 0 & 0 & 0 & 0 & 0 & - 1 & 0 & 0 & 0 & 0 & 0 \\ - 1 & 0 & 0 & 0 & 0 & 0 & 0 & 0 & 0 & 0 & 0 & 0 \\ 0 & - 1 & 0 & 0 & 0 & 0 & 0 & 0 & 0 & 0 & 0 & 0 \\ 0 & 0 & 0 & 0 & 0 & 0 & 0 & 1 & 0 & 0 & 0 & 0 \\ 0 & 0 & 0 & 0 & 0 & 0 & 0 & - 1 & 0 & 0 & 0 & 0 \\ 0 & 0 & 0 & 0 & 0 & 0 & 0 & 0 & 1 & 0 & 0 & 0 \\ 0 & 0 & 0 & 0 & 0 & 0 & 0 & 0 & 0 & 1 & 0 & 0 \\ 0 & 0 & 0 & 0 & 0 & 0 & 0 & 0 & 0 & 0 & 1 & 0 \\ 0 & 0 & 0 & 0 & 0 & 0 & 0 & 0 & 0 & 0 & 0 & 1 \\ 0 & 0 & 0 & 0 & 0 & 0 & 0 & 0 & 0 & 0 & - 1 & 0 \\ 0 & 0 & 0 & 0 & 0 & 0 & 0 & 0 & 0 & 0 & 0 & - 1 \\ 0 & 0 & 0 & 0 & 0 & 0 & 0 & 0 & - 1 & 0 & 0 & 0 \\ 0 & 0 & 0 & 0 & 0 & 0 & 0 & 0 & 0 & - 1 & 0 & 0\end{matrix} ] [ \begin{matrix}{u}_{reduced , 1} \\ {u}_{reduced , 2} \\ ⋮ \\ {u}_{reduced , 12}\end{matrix} ] \qquad ( 1 )$$

In some embodiments, this cable coupling has been achieved in hardware through the use of clever mechanisms and/or pulleys. This paired-cable schema has some practical advantages over a 24-motor schema. Some of the most notable advantages are that fewer parts are necessary, and consequently, that the tensegrity robot weighs significantly less and is less prone to mechanical failures.

The tensegrity structure of such robots can be actuated to achieve dynamic movement. Examples of achievable dynamic movement with this design can include, but are not limited to, rolling along even or uneven ground. The dynamic movement of such tensegrity structures can be achieved by manipulating the tension distribution in their series-elastic structure. This new design can achieve improved and more efficient shape-shifting behavior through software and hardware innovations that reduce the number of actuators required in such robots.

According to some embodiments of the current invention, robots can capitalize on the beneficial properties of tensegrity systems, such as low mass, impact resilience, variable stiffness, and redundancy to failure, but because this novel design requires fewer actuators, these new mobile robots can be lighter, less complex, and less costly than their predecessors.

The scheme of multi-cable actuation requires a realization of a software control system that directs the higher-level motion planning of the robot. Specifically, according to some embodiments, sensor data from the robot is analyzed and processed using either edge computing or wireless communication to a remote master computer/controller. Examples of uses for the multi-cable actuation controller include generating locomotion strategies, reconfiguration of the robot shape, recalibration of sensor measurements, and updating the current state of the robot, etc.

In such embodiments, a master controller leverages aggregated sensor information to compute optimal control strategies that are communicated back to the robot for execution. In other embodiments, the robot itself computes optimal actuation strategies directly by leveraging its own distributed control and local system information.

The multi-cable actuation design for tensegrity robots of some embodiments is based on a structure made up of six (6) rods (also referred to as bars) and 24 tension elements (which can be any type of series elastic elements, such as bungee cords, elastic bands, nylon cables with springs, etc.). The term “cable” is to be understood as an example of one particular embodiment of a tension element. The general concepts of the current invention are not intended to be limited to that particular example.

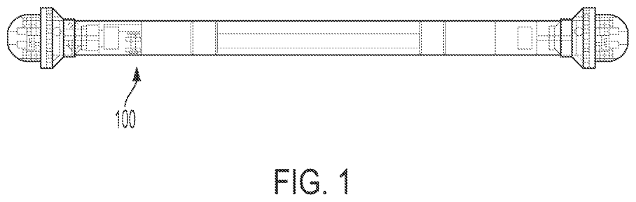

FIG. 1 shows an example of a rod 100 that can be used in the design of some embodiments. Similarly, the term “rod” is intended to have a broad meaning to encompass any axially elongated structure that is suitable to be included in a tensegrity robot for a particular application. In such rod-actuated embodiments, the rod houses the actuator (or motor). The actuator can be located anywhere in the rod but is most often located at the end of or in the middle of a rod.

Another approach to simplify the six-bar spherical tensegrity design is to use a single centralized mechatronic payload of electronics which includes all of the actuation, sensors, and on-board compute in one compact package. As opposed to the paradigm of using six distributed rods with independent microcontrollers which work in tandem through wireless communication, embodiments with this center-payload spherical tensegrity topology seek to reduce redundancy, weight, and costs while still having the capability to roll in any direction.

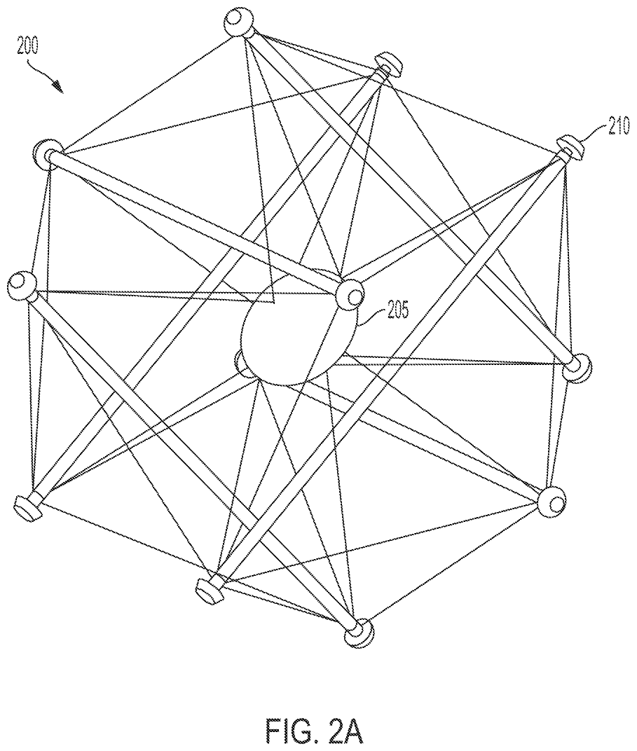

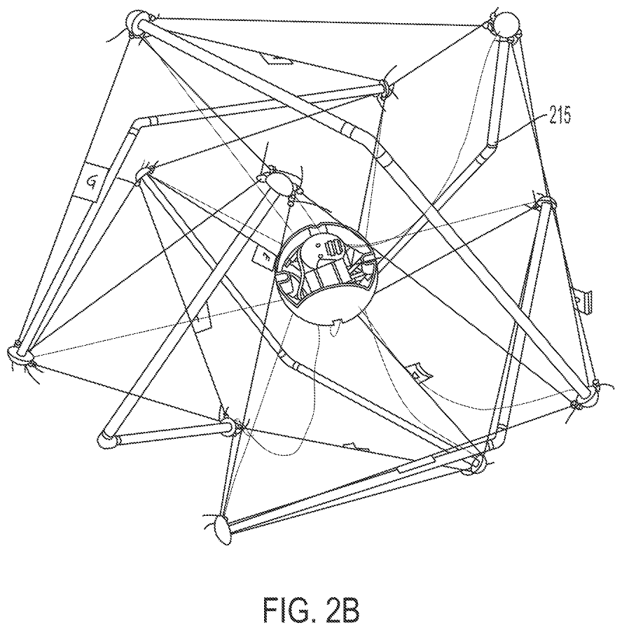

FIG. 2A shows an example of a center-payload embodiment 200 of a spherical tensegrity robot, which houses all active components of the robot in a spherical payload 205 that is suspended in the interior space of the robot using 12 inner-cables. Actuators within the payload manipulate the controllable tensions of the 12 inner-cables in order to move the payload within the interior space of the outer shell, changing the robot's center of mass to cause an unstable transition from one face to another. The simplified design of this center-payload topology reduces redundancy in the system, minimizing the number of necessary actuators from 24 down to 12 or even 6 motors. The external cables 210 are passive and unactuated in this example.

While seemingly intuitive, initial studies [1] had presented numerous challenges for the idea of a centrally-actuated tensegrity due to an inability to move the payload sufficiently far as to reliably induce a rolling motion and the need for accurate sensing for reactive control. From simulation results with realistic hardware components, it was determined that in order achieve ground mobility, an expanded internal volume was necessary in order for there to be enough travel for the center payload to cause a rolling motion. To achieve this, in some embodiments, the traditionally straight rigid bodies common to most six-bar designs were replaced with bent rods 215 which can range between 127 to 140 degrees in order to provide the payload with a greater workspace. With this update geometry, motion planning simulations demonstrated successful results using all 12 inner-cables with cable rest lengths constrained between 1 cm to 15 cm for a robot of 60 cm diameter. An example of a bent-rod, center payload embodiment is illustrated in FIG. 2B.

Some embodiments for multi-cable actuation of cable-driven tensegrity robots differ from previous actuation designs in two significant ways—the design of some embodiments greatly reduces the required power density of each actuator and reduces the total number of actuators needed.

Some embodiments significantly improve the overall mobility performance of the robot by reducing the effective load imparted to each motor actuator—the load is reduced due to complementary tension. Some embodiments allow for the construction of impact-resilient robot systems capable of versatile mobility strategies at lower cost and lower mechanical complexity (i.e., fewer parts). Some embodiments incorporate bearings and integrate a more-protective covering that enable the multi-cable operation and permit higher tension loads.

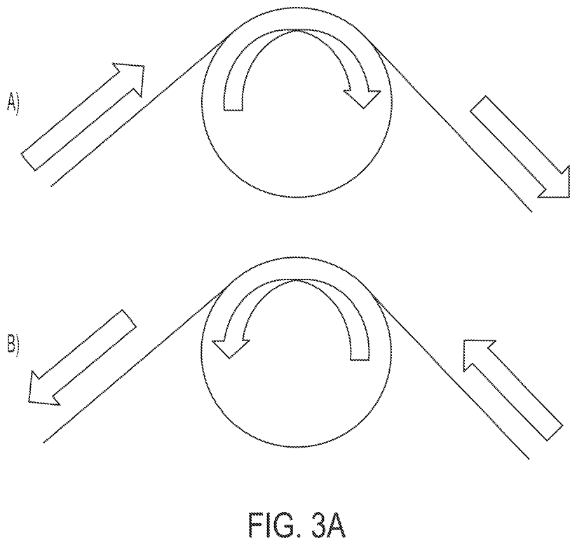

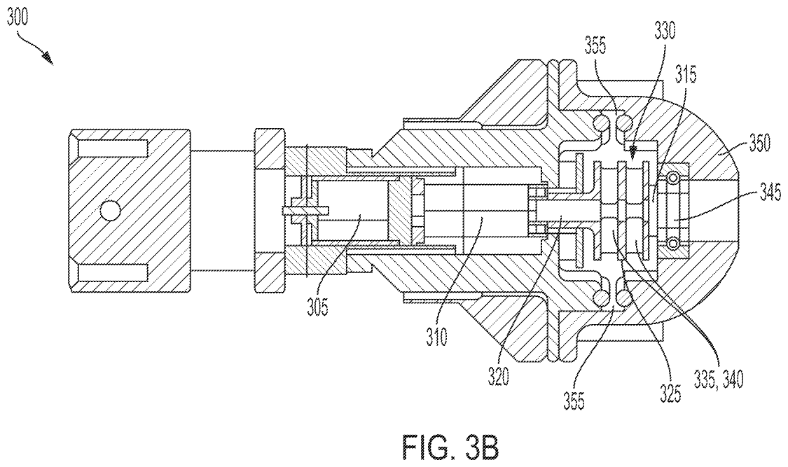

FIG. 3A conceptually illustrates an embodiment with paired-cable actuation control of 24 cables using only 12 motors (represented in gray), at the cost of dynamic coupling and reduced control authority. Extensions (retractions) of one cable's rest length mean that the complement cable's rest length must retract (extend). In other embodiments, multiple cables can be wound tighter (e.g., retracted) using the same actuator without necessarily unwinding other cables. Similarly, in other embodiments, multiple cables can be unwound without any other cables being retracted.

FIG. 3B shows the hardware design of an embodiment using a rod-located actuator. In this embodiment, the rod 300 is a lightweight carbon fiber tube. The actuator is a brushed DC motor 305 with a gearhead 310. The cable pulley 315 is situated over the gearhead output shaft 320; the pulley's rotation is driven by the gearhead output shaft 320. The cable pulley itself can be made with some low-weight, high-strength material, such as aluminum or titanium. The pulley supports two (2) actuated cables, 325 and 330, that wrap around the pulley's two grooves, 335 and 340. In this embodiment, the cables are high-strength nylon polymer cables in series with aluminum extension springs. The cables are wrapped in opposite directions (one clockwise, one counterclockwise). When actuated, one cable wraps while the other cable unwraps as a result of software commands and pulley and gearhead output shaft operations. Other embodiments can use more than two cables per actuator. In some embodiments, multi-cable actuation increases the desired force output, thereby improving the mobility and structural integrity of the design. In such an embodiment, the cables still wrap and unwrap around a single pulley. In some embodiments, additional passive cables may be included within the design for increased structural integrity of the tensegrity system; such passive cables are not essential to the multi-cable scheme.

In some embodiments, each of the two actuated cables, 325 and 330, can be wrapped around and secured relative to the pulley by using some clamp or set screw. In other embodiments, each cable can be freely wrapped around the output pulley, relying solely on intrinsic tension and capstan friction to prevent slippage of the cable relative to the pulley's rotational position.

In the example of FIG. 3B, the actuator, pulley, and cable components are held in place by means of a ball bearing 345 housed within a protective covering 350. In this embodiment, the housing is Polylactic Acid (PLA) plastic, but in other embodiments housing could be any smooth-finished material, such as, but not limited to, titanium, Delrin, or aluminum. The smooth surface of the protective covering 350 aids in mobility, particularly related to rolling location.

During mobility operations, each of the actuated cables, 325 and 330, must exit the protective covering. In this embodiment, the two cables, 325 and 330, slide between precision dowel pins 355 that reduce contact friction during cable movement. Friction can be further reduced by using smooth surfaces at all intermediary points in contact with the cables. Another significant improvement in some embodiments is a simplified tensegrity system design and assembly, by incorporating consistent pre-stressed cable tensions.

Possible variations in this design embodiment include the use of different types of material, different motor-pulley-cable assembly locations, and different series-elastic cable configurations. Such variations could include using elastic bungee cables or laser-cut elastic sheets as elastic elements or using torsional or compression springs at the motor output rather than extension springs at the ends of the cables, for example. The general concepts of the current invention are not limited to these examples. Additionally, the motor-pulley-cable assembly is in some embodiments internally located closer to the center of the rod for improved impact protection at the expense of increased friction due to longer cable routing.

Other possible variations in this design embodiment may be based around the number of cables used with a specific actuator. Uneven distribution of the cable tension elements is beneficial in some embodiments to achieve mechanical advantage as well as to improve specific types of dynamic motion. For example, improved motion and reduced energy consumption might be achieved with a 3-to-2 combination.

In some embodiments, control and motion planning are facilitated with a suite of sensors. The sensors are located in some embodiments in a central payload, the rods, or a combination of the two. In some embodiments, the sensors include a 9-axis inertial measurement unit (IMU) in each rod which obtains fused information from individual sensors such as three-axis accelerometers, gyroscopes, and magnetometers in order to measure the rods' accelerations, angular velocities, and orientation with respect to some inertial frame. Additionally, sensor information from a motor's angular position can be used in some embodiments to measure the cable rest length for each associated cable, and approximate tension sensing is possible in some embodiments through sensing the current draw from each DC motor. Some embodiments use wideband time-of-flight range sensors for position measurements. In some embodiments, disparate sensor measurements of orientation, cable length, nodal velocity, etc. are combined (e.g., using Bayesian sensor fusion techniques and state observers) for more accurate state and pose estimation than can be achieved solely through independent, isolated sensor measurements.

Some embodiments of the current invention can improve the simplicity, reliability, and energy-efficiency of dynamic tensegrity robots. Tensegrity robots are useful in applications where soft (i.e., “squishy”) robots may be useful, such as co-robotic applications around people or when dealing with uncertain environments. A notable application is for disaster/emergency response robotics.

Other potential uses can include spherical tensegrity structures, spherical tensegrity robots, four-legged robots, rapid prototyping fits for tensegrity system research, educational toys, artwork, space exploration (e.g., planetary landers and explorers), hazardous environment explorers, and cargo delivery through aerial dropping (e.g., from an unmanned aerial vehicle).

### EXAMPLES

The following describes some concepts of the current invention with reference to particular embodiments. The general concepts of the current invention are not limited to the examples described.

Example of Paired-Cable Use Case

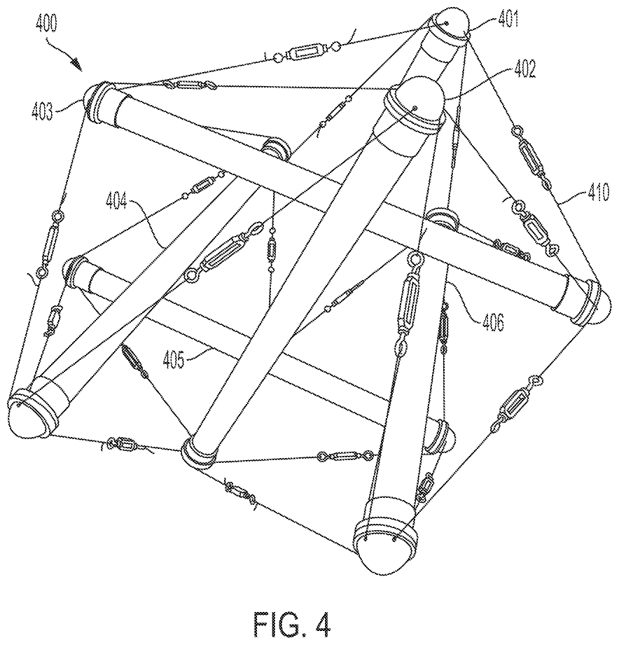

A common tensegrity design of some embodiments is that of the six-bar spherical tensegrity robot 400 pictured in FIG. 4. Its prominence is due to the fact that six rigid members 401-406 are the minimum number of rigid elements necessary for a symmetrical spherical design. This design embodiment is advantageous for rolling-like mobility, able to achieve locomotion by adjusting individual cables (e.g., 410) to control a shapeshifting behavior and manipulate the robot's center of gravity.

Traditional hardware designs feature individual cable actuation—individual cable elements are independently controlled using a single motor actuator (e.g., a brushed DC motor). The proposed underactuated paired-cable designs of some embodiments leverage complementary tension in order to: 1) reduce the number of motors necessary for mobility and 2) improve energy efficiency of the robot's locomotion.

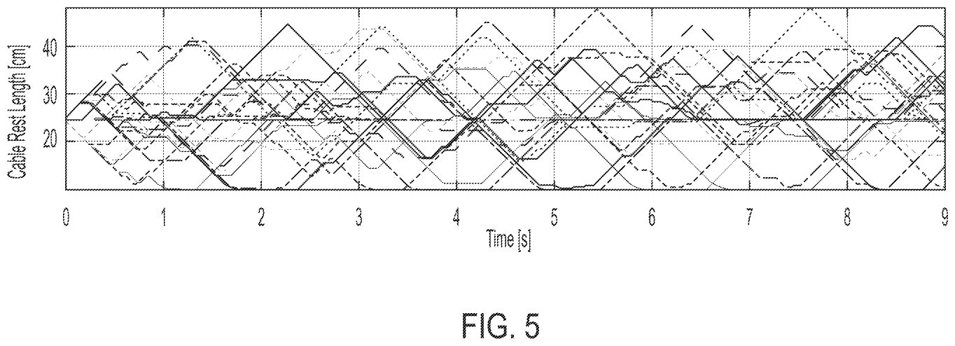

The challenges of implementation exist both in hardware and software. In hardware, various prototypes were implemented which address issues with cable tangling and slackness. Through software simulations, different actuation configurations were rapidly prototyped and optimized to quickly identify which paired-cable combinations are feasible and effective. To highlight the combinatorial challenge of choosing the optimal manner in which to control cables, FIG. 5 depicts the dynamic nature of changing cable lengths over time for a periodic rolling gait (each different line style represents one of 24 independent cables).

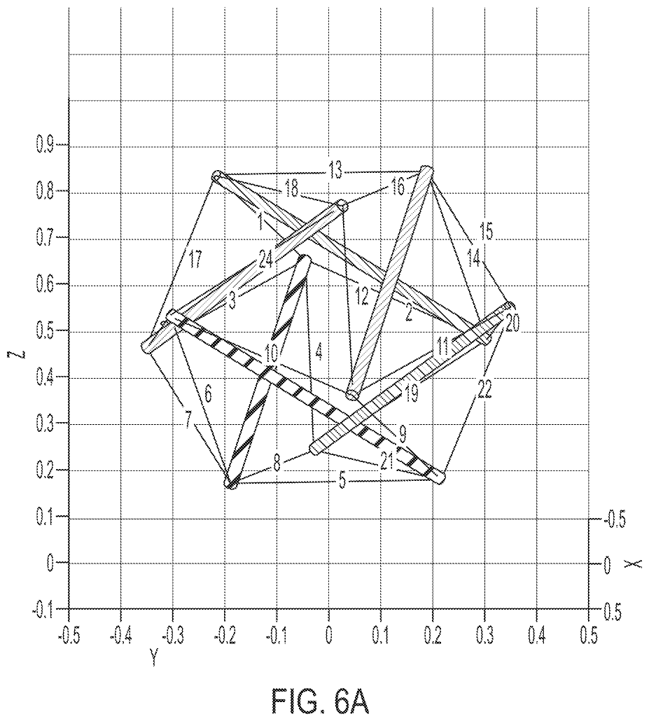

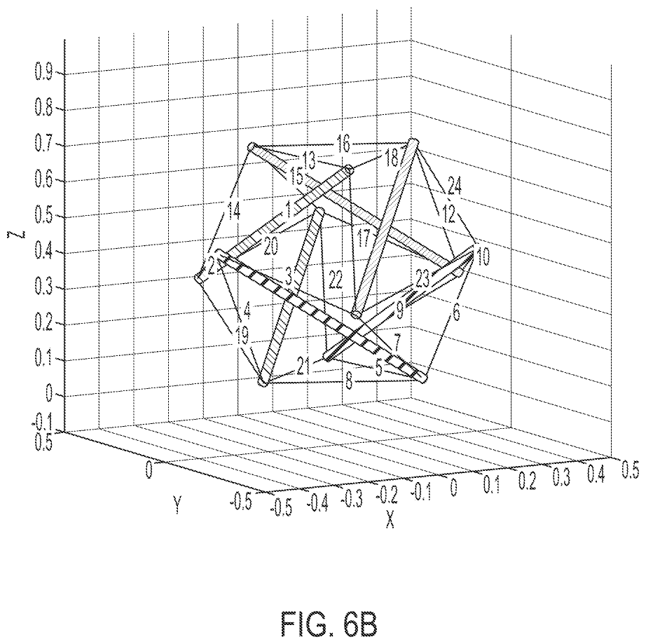

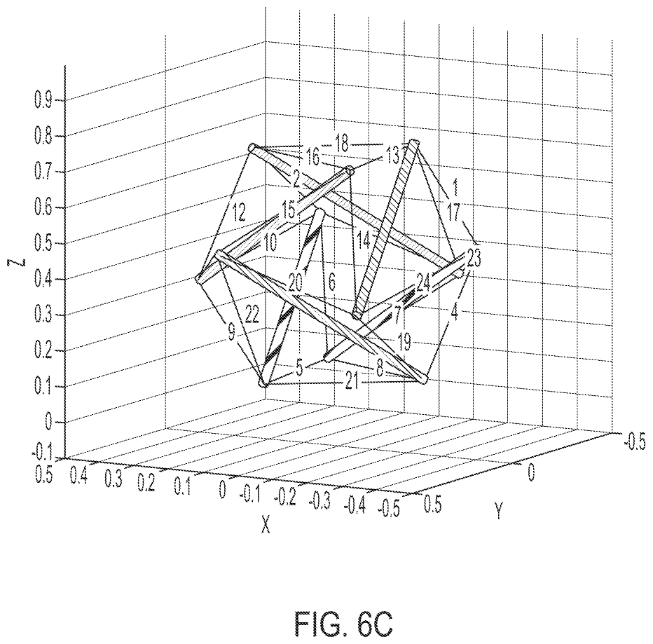

Different paired-cable actuation schemas can be discovered by using a custom-framework in some embodiments to simulate and optimize different cable actuation constraints and performance metrics according to user-defined design criteria such as energy efficiency, speed, or directional control during mobility. Iterative approaches such as genetic algorithms may leverage the simulation framework for parametric studies of different mechanical variables (e.g., cable stiffness, cable pretension, rod mass, etc.). One example of a paired-cable actuation schema for the six-bar spherical design is outlined in Table 1 below according to the cable convention shown in FIGS. 6A-6C (each view depicts a 120-degree view rotation about the Z-axis):

TABLE 1

| Pair | | | | | | | | | | | | |
|---|---|---|---|---|---|---|---|---|---|---|---|---|
| Number | 1 | 2 | 3 | 4 | 5 | 6 | 7 | 8 | 9 | 10 | 11 | 12 |
| Cable A | 1 | 2 | 3 | 5 | 6 | 7 | 11 | 15 | 17 | 18 | 19 | 20 |
| Cable B | 13 | 14 | 4 | 9 | 10 | 8 | 12 | 16 | 23 | 24 | 21 | 22 |

Notably, although the paired-cable approach is outlined specifically for the six-bar spherical tensegrity robot 400 embodiment described above, this approach can be leveraged for any cable-driven tensegrity robot system to allow for underactuated control while still achieving critical performance objectives.

The embodiments illustrated and discussed in this specification are intended only to teach those skilled in the art how to make and use the invention. In describing embodiments of the invention, specific terminology is employed for the sake of clarity. However, the invention is not intended to be limited to the specific terminology so selected. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

### Example of 12-Motor Paired-Cable Actuation Scheme

This work introduces a novel 12-motor paired-cable actuation scheme to achieve rolling locomotion with a spherical tensegrity structure. Using a new point mass tensegrity dynamic formulation, Model Predictive Control is utilized to generate optimal state-action trajectories for benchmark evaluation. In particular, locomotive performance is assessed based on the practical criteria of rolling speed, energy efficiency, and directional trajectory-tracking accuracy. Through simulation of 6-motor, 12-motor paired-cable, and 24-motor fully-actuated policies, the 12-motor schema is demonstrated to be superior to the 6-motor policy in all benchmark categories, comparable to the 24-motor policy in rolling speed, and is over five times more energy efficient than the fully-actuated 24-motor configuration.

### Introduction

Spherical tensegrity robots (tensegrities) are lightweight soft robots that are comprised of an elastic tension network that suspends and connects isolated rigid rods. A six-bar spherical tensegrity 400, as shown in FIG. 4, has six rigid rods 401-406 held together by 24 series-elastic cables 410. Each rod is 60 cm in length. This spherical tensegrity robot 400 locomotes through shape-shifting by controlling individual cable tensions.

Notably, the structural properties of compliant and low-weight tensegrities have proven to be advantageous in applications that involve high-impact loads and co-robotic cooperation with humans; potential applications for these tensegrity robots include space surface exploration rovers [1] and disaster response robotics. However, the performance and energy efficiencies of spherical tensegrity robots has yet to be evaluated for practical use cases in realistic scenarios.

Motion planning and optimal control for rolling locomotion has been a major driving force for tensegrity research in recent years. As a result, innovative approaches utilizing evolutionary algorithms, data-driven methods, and model-based optimal control have all been developed to control these novel complex robots. In particular, great emphasis has been placed on optimal performance with respect to rolling speed under non-ideal conditions and rough terrain, but less consideration has been made for practical implementation challenges such as energy efficiency, controllability, and directional trajectory-tracking accuracy.

The goals of this example are to introduce and evaluate a novel 12-motor paired-cable actuation scheme for tensegrity locomotion, presenting new tools and benchmarks to adequately assess the performance of a tensegrity's mobility with respect to energy efficiency, rolling speed, and directional trajectory-tracking. Understandably, the values for these benchmarks heavily depend on the hardware design—the number of actuated cables, the actuators used, and which specific cables are controlled. Nevertheless, this preliminary exploration into these quantifiable metrics potentially elucidates a greater understanding of practical tensegrity hardware and control policy design for future mobile tensegrity robots.

First, the new point mass tensegrity dynamics are explored in great detail to demonstrate how equations of motion for the tensegrity dynamics can be easily constructed in a rigorous and procedural manner. Next, an approach for motion planning is outlined through the use of Model Predictive Control (MPC) in conjunction with the new point mass formulation. Lastly, the approach's versatility is demonstrated by generating optimal state-action trajectories for different tensegrity actuation configurations and evaluating their locomotive performance using relevant benchmarks.

Prior Research

Various rolling locomotion control policies and actuation configurations for spherical tensegrities have been explored. Developments in single-cable actuation (i.e., where only one cable is actuated at a time) have chiefly relied on the design and analysis of hand-engineered control policies [2], [3]. In contrast, due to the nonlinear coupled dynamics of spherical tensegrity structures, multi-cable actuation (i.e., simultaneous actuation of all 24 cables) has proven to be a significantly more challenging task. Methods to explore multi-cable actuation primarily consist of Monte Carlo simulations and data-driven machine learning methods.

In recent years, research in multi-cable actuation for tensegrities, [4], [5], has found that locomotion by rolling can be achieved by shape-shifting to a desirable quasi-static geometry that positions the center of mass outside of the support polygon, and recent advancements in continuous rolling locomotion for tensegrities have utilized deep reinforced learning [6], [7].

Finally, many tensegrity topologies and actuation configurations have been explored. Numerous designs of even just spherical tensegrities have demonstrated variability in the number of actuated cables, degrees of freedom, overall compliance, weight distribution, etc. Continuing on the innovations of these explorative hardware designs, this paper presents a novel 12-motor paired-cable actuation scheme and compares its performance to other schemes using standard benchmarks of energy efficiency, rolling speed, and directional trajectory-tracking.

The Six-Bar Spherical Tensegrity Robot and Point Mass Dynamics

This paper focuses on the Class-1 spherical tensegrity topology. Specifically, Class-1 tensegrities are special tensegrity structures constructed with compressive bodies which bear no rigid joints and which are interconnected solely through series-elastic tensile elements. For this reason, Class-1 tensegrity dynamic equations of motion are well-structured and can be procedurally obtained when given a fixed set of parameters. In prior work [8], a minimal representation of the 3D rigid body dynamics for tensegrity systems is presented. While the reduced state-dimension of this minimal representation is advantageous, this particular formulation is susceptible to dynamic singularities, which can make robust and reliable motion planning and optimal control difficult. In this section, a new simplified point mass tensegrity dynamics representation is presented which can be easily formulated for any Class-1 tensegrity structure.

For this point mass formulation, rather than representing true rigid body dynamics, it is assumed that the entirety of each rod's mass can be distributed between two point masses located at the ends of the rod, hereafter also referred to as nodes. Notably, this assumption's validity is largely dependent on the actual hardware design of the tensegrity robot; as an example, consider the tensegrity SUPERball [1] designed by the Intelligent Robotics Group at NASA Ames, which carries most of its mass closer to the ends of the rod, where heavier motor assemblies and electronics are housed. Thus, this point mass assumption can often be relatively accurate and greatly simplifies the formulation of tensegrity dynamic equations of motion, enabling rapid design and prototyping of new innovative topologies in simulation.

With these simplifying assumptions, only the positions, velocities, and accelerations of each point mass are considered. Vectors p and \dot{p}∈ [symbol] ^{3N} are defined containing the individual xyz positions and velocities of the N nodes as:

p=[x₁,y₁,z₁, . . . ,x_{N},y_{N},z_{N}]^{T} (2)

\dot{p}[x₁,y₁,z₁, . . . \dot{x}_{N},\dot{y}_{N},ż_{N}] (3)

Next, it is assumed that forces are imparted on each node purely through idealized two-force members (i.e., the rods and cables in pure compression/tension) or from the external environment (e.g., contact forces with the ground). For the remainder of this section, the dynamic formulation of the cable and rod forces intrinsic to tensegrity structures is discussed.

Series-Elastic Cable Forces

Forces which act on the nodes due to the spring-cables are calculated simply using Hookean approximations, with special consideration that no compressive forces can be applied through the cables:

F_{cables,j}=max{0,kⱼ,(Sⱼ−Lⱼ)} (4)

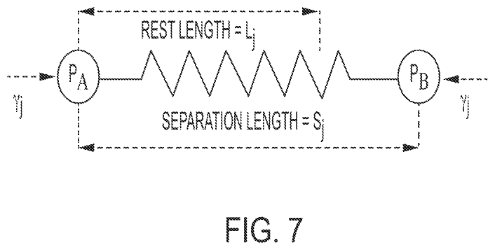

Here kⱼ is the stiffness of the series-elastic cable j, Sⱼ is the separation distance between the two end nodes attached to cable j, and Lⱼ is the spring-cable assembly rest length, as shown in FIG. 7, which illustrates a Hookean linear-elastic model between two point masses.

Given a cable connectivity matrix C∈ [symbol] ^{J×N} (see [8] for details), with rows Cⱼ that encode cable interconnections between pairs of nodes, elements in the vector of cables forces, γ∈ [symbol] ^{J}, are represented as:

$${γ}_{j} = \sqrt{2} {k}_{j} \cdot softplus ( {α}_{j} , β ) \frac{{z}_{j}}{{‖ {z}_{j} ‖}_{2}} ∀ j ∈ \{ 1 , … , J \} \qquad ( 5 a )$$

where variables zj and αj are defined as follows:

$${z}_{j} = - [ {C}_{j}^{T} {C}_{j} ⊗ {I}_{3} ] p \qquad ( 5 b )$$

$${α}_{j} = ( {S}_{j} - {L}_{j} ) = \sqrt{\frac{{z}_{j}^{T} {z}_{j}}{2}} - {L}_{j} \qquad ( 5 c )$$

Here, zⱼ∈ [symbol] ^{J} is a sparse vector that contains the directional vector lying along the direction of the cable j. The softplus function above is a smooth approximation to the non-differentiable rectifier function (used in Eq. 4), approximating max {0, αᵢ} with tunable smoothness parameter β:

softplus(αⱼ,β):=(\sqrt{αⱼ²+β²}+αⱼ)/2≥0 (6)

In practice, this Lipschitz smooth approximation demonstrates better numerical stability in simulation and its continuously differentiable property is well-suited for calculating the locally-linearized dynamic models used in the receding horizon control methods discussed in later sections.

Rigid Body Constraint Forces

The other set of essential forces in tensegrity structures are the rigid body constraints, which constrain the nodal positions relative to each other and the environment.

Rather than model the rods using a linear-elastic model as with cable forces in the prior section, a constrained dynamics approach is instead adopted. The motivation behind this is that penalty or energy barrier methods, which rely on restorative forces to maintain rigid connections, necessitate large stiffness parameters and lead to stiff differential equations. Instead, the constraint forces describe here neatly cancel out the components of the applied forces that violate rigid constraints at each timestep, creating accurate and numerically tractable dynamic simulations.

This work adopts a similar approach to [9] and defines constraint vectors, G(p) and Ġ(p)∈ [symbol] ^{M}, to represent the implicit constraint functions and their time derivatives, where M is the number of active dynamic constraints. Each scalar element Gᵢ(p) is a single implicit constraint function that is satisfied when equal to zero. If it is assumed that initial positions and velocities of the system satisfy dynamic constraints (i.e., G(p)=0 and G̅(p)=0), then any forces which maintain legal accelerations (i.e., \ddot{G}(p)=0) will be valid forces which satisfy all dynamic constraints.

The vector of legal forces F^{J} which are ultimately applied to the particle masses is decomposed into two components: F, the total forces originally applied to the particle, and \hat{F} which are resultant constraint forces that cancel out any illegal accelerations. The inverse-mass matrix W is also introduced, which contains the reciprocal of each particle's mass as elements along the diagonal. Thus, the legal acceleration condition can be written as:

$$\ddot{G} ( p ) = [ \frac{\partial G ( p )}{\partial p} ] \dot{p} + [ \frac{\partial G ( p )}{\partial p} ] \ddot{p} \qquad ( 7 )$$

$$= [ \frac{\partial \dot{G} ( p )}{\partial p} ] \dot{p} + [ \frac{\partial G ( p )}{\partial p} ] W ( F + \hat{F} ) = 0 \qquad ( 8 )$$

Simplifying notation of

$$[ \frac{\partial G ( p )}{\partial p} ] and [ \frac{\partial \dot{G} ( p )}{\partial p} ]$$

as matrices J(p) and J(p), respectively and dropping the matrices' explicit dependencies on p, it can be rewritten:

JW\hat{F}=\dot{J}\dot{p}−JWF (9)

JW(J^{T}λ)=−\dot{J}\dot{p}−JWF (10)

where (Eq. 10) is a result of (Eq. 8) in combination with the principle of virtual work, which restricts constraint forces \hat{F} to lie in the subspace spanned by the constraint gradient vectors (i.e., the rows of

$$\frac{\partial G ( p )}{\partial p} ) .$$

The vector λ of Lagrange multipliers determines how much of each constraint gradient is applied, providing a measure proportional to the reaction force applied due to the corresponding constraint. To prevent the accumulation of numerical drift, corrective stiffness and damping terms are appended to (Eq. 10):

JW(J^{T}λ)=−\dot{J}\dot{p}−JWF−kₛG−k_{d}Ġ (11)

As a concrete example, consider the constraint forces imposed by the rigid body connection between two endpoint nodes of a rod. Given nodal positions and velocities, rod length L_{rod,q}, and a rod connectivity matrix R∈ [symbol] ^{Q×N} with rows R_{q} that encode rod interconnections, an implicit rod constraint function constraining relative distance between nodal positions p_{A} and p_{B}, the constraint function's respective time derivative, and their associated Jacobian matrices are written as:

Gᵢ(p)=∥p_{B}−p_{A}∥₂²−L_{rod,q}² (12)

=½p^{T}([R_{q}^{T}R_{q}]⊗I₃)²p−L_{rod,q}² (13)

Ġ_{ι}(p)=p^{T}([R_{q}^{T}R_{q}]⊗I₃)²\dot{p} (14)

Jᵢ(p)=p^{T}([R_{q}^{T}R_{q}]⊗I₃)² (15)

\dot{J}_{ι}(p)=\dot{p}^{T}([R_{q}^{T}R_{q}]⊗I₃)² (16)

Given these implicit constraint functions which are obtained for each rod, these results are combined with the formulas in previous sections above to guarantee that nodal accelerations are realistically and stably simulated, with no pair-relative acceleration components lying along the axis of the rigid rods.

Motion Planning Using Model Predictive Control

Tensegrity motion planning and control can be overwhelmingly complex due to the high-dimensional, highly-coupled, nonlinear dynamics inherent to tensegrity robots. Generating optimal state-action trajectories (i.e., the control and time evolution of actuated cable rest lengths and the resulting dynamic states) can be a difficult task when considering the entirety of the 72-dimensional state-space and up to 24-dimensional action-space. Fortunately, the well-structured dynamics of Class-1 tensegrities are leveraged by importing the dynamic equations of motion derived above as optimization constraints for model-based receding horizon control such as Model Predictive Control (MPC).

In short, MPC is a control schema which iteratively solves a constrained optimization problem and implements only the first control input at the each timestep [10], [11]. The primary benefit of this control scheme is the ability to leverage dynamic models to optimize future behavior over finite time-horizons while also complying with state and input constraints, such as those defined by realistic safety and actuator limitations. Additionally, because MPC is an iterative algorithm, the approach is inherently robust to unforeseen disturbances.

In this work, MPC is utilized to automatically design and evaluate tensegrity locomotion actuation policies (i.e., how to optimally actuate cable rest lengths). The continuous dynamics of the robot are linearized about the robot's current state and discretized using a trapezoidal approximation:

$$[ \begin{matrix}{p}_{k + 1} \\ {\dot{p}}_{k + 1}\end{matrix} ] = [ \begin{matrix}{p}_{k} \\ {\dot{p}}_{k}\end{matrix} ] + \frac{dT}{2} [ \begin{matrix}{\dot{p}}_{k} + {\dot{p}}_{k + 1} \\ 2 {\ddot{p}}_{0} + \frac{\partial \ddot{p}}{\partial x} {\tilde{x}}_{k} + \frac{\partial \ddot{p}}{\partial x} {\tilde{x}}_{k + 1}\end{matrix} ] \qquad ( 17 )$$

Where dT is the simulation timestep, x∈ [symbol] ⁹⁶ is a concatenated vector of cable lengths and nodal position/velocity states, \tilde{x}ₖ is the deviation about the linearization point x₀, and \ddot{p}₀∈ [symbol] ^{3N} is the current state acceleration at x−x₀, where \ddot{p} is calculated as follows:

\ddot{p}=W(−J^{T}(JWJ^{T})⁻¹(\dot{J}\dot{p}−kₛG−k_{d}Ġ)+I−J^{T}(JWJ^{T})⁻¹JW)(Σᵢ^{J}γᵢ+Fₑₓₜ)) (18)

(Eq. 18) is obtained by combining the results of the derivations above. Note, Fₑₓₜ are the total forces applied to the tensegrity robot which are external to the system (e.g., ground contact reaction forces) and are calculated using damped linear-elastic collisions. These formulas are similar to those discussed previously, and thus a formal discussion of these external force calculations is excluded for the sake of brevity.

Using the derived linearized and discretized dynamics as optimization constraints, the following cost function is minimized:

Σₖ₌₁^{T}ψ^{k-1}{−θ₁Σᵢ₌₁^{N}\dot{p}ᵢ^{T}D+θ₂∥\hat{L}ₖ∥₁+θ₃∥Lₖ∥₁} (19)

Here D∈ [symbol] ³ is the desired direction of travel, T is the MPC finite-time horizon, and ψ<1 is a discount factor placing less weight on later states to account for linearization errors. Finally, θ1, θ2, θ3 are weighting parameters, and Lₖ and Lₖ E [symbol] contain deviations of the k^{th} step cable rest lengths about the neutral pretensioned lengths and initial lengths used for linearization, respectively. Combined, these cost terms reward rolling velocity in a desired direction while simultaneously penalizing cable rest length deviations from both initial pretensioned lengths and current rest lengths (i.e., k=1), respectively, preventing the robot from excessive deformations and generating sparse motor actuation.

The convex cost function above and linear equality and inequality constraints from the dynamics, state/actuator limits, and initial conditions thus form a linear program which is easily minimized using any convex optimization solver. For this work, Gurobi Optimizer and YALMIP [12] were used in MATLAB to solve the optimization problem at each timestep iteration. Combined, these tools enable us to rapidly evaluate the novel 12-motor tensegrity actuation policy and its relative performance.

12-Motor Paired-Cable Actuation

Similar to the 24-motor actuation scheme, the 12-motor paired-cable actuation scheme controls all 24 cables in a spherical tensegrity; however, for the 12-motor scheme, two cables are coupled by a single motor. For this actuation scheme, a pair of cables meet at a single node—the retraction of one cable means the extension of the other cable in that pair. Thus, while all 24 cables are actuated, only 12 degrees of freedom exist in the system.

Interestingly, this new paired-cable schema has some practical advantages over its 24-motor schema counterpart. The most immediate advantages are that fewer parts are necessary, so the robot is less prone to mechanical failure, and that the tensegrity robot will weigh significantly less.

Comparisons of Rolling Locomotion Strategies

In this final section tensegrity rolling locomotion is discussed in detail and three cable-actuation schemes are compared, each with varying degrees of control authority: 6-motor (underactuated), 12-motor (paired-actuation), and 24-motor (full-actuation) schema. In particular, these actuation schema vary the number of cables that are driven by motor actuators and consequently which cables remain as passive tensile elements. As a result, it is demonstrated that greater control authority can provide improved performance at the cost of additional hardware and controller complexity.

In the results that follow, MPC is utilized with the dynamic constraints introduced earlier to generate optimal state-action trajectories for evaluation. Notably, the simulation model parameters used in these experiments are based on actual hardware parameters of tensegrity robots such as shown in FIG. 4. Sample values and ranges of these parameters according to some embodiments are summarized in Table 2.

TABLE 2

| Physical Parameters | Values |
|---|---|
| Rod Length | 60-100 cm |
| Rod Mass (nominal) | 500-1100 g |
| Cable Stiffness | 400-515 N/m |
| Pretension | 22-50 N |
| Max. Cable Linear Velocity | 20 cm/s |

For the remainder of this section, various characteristic properties of tensegrity locomotion are discussed. First, the 24-motor fully-actuated scheme is used to illustrate hardware and controller design considerations that are unique to compliant tensegrity rolling locomotion; namely, it is asserted that tensegrity stiffness and initial pretension are important hardware and controller design hyperparameters. This section concludes by evaluating the nominal performance of the three common actuation schema introduced above with respect to relevant performance metrics such as speed, directional trajectory-tracking, and energy efficiency.

Effective Tensegrity Stiffness and Pretension

The inherent compliance of tensegrity structures serves as a benefit with regards to mechanical robustness, particularly in the structure's impact-resilience, natural force distribution, and lack of mechanical stress concentrators. On the other hand, the resulting oscillatory dynamic behavior complicates optimal control policy design. This section presents results obtained when adjusting overall tensegrity stiffness and pretension (i.e., the stiffness and initial pretension of all individual series-elastic tension elements) and assess its broader effects on rolling locomotion. For this evaluation, the relative dynamic behavior of the robot is examined as the overall stiffness and pretension of the fully-actuated robot is adjusted between 50% and 200% of the nominal values of 400 N/m and 50 N. The simulation parameters used for MPC are listed in Table 3:

TABLE 3

| Timesteps | dT | T | Ψ | θ₁ | θ₂ | θ₃ |
|---|---|---|---|---|---|---|
| 500 | 0.01 | 10 | 0.95 | 1.0 | 3.0 | 3.0 |

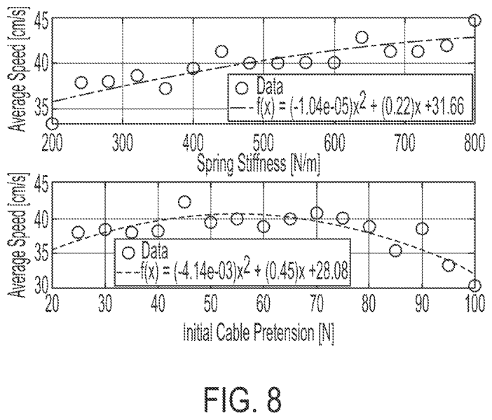

FIG. 8 shows a comparison of average rolling speeds vs. overall stiffness and initial cable pretension, with 24-motor scheme. Near-linear fitting curves highlight the overall trends. As seen from the results in FIG. 8, greater overall stiffness in the robot leads to better rolling performance with the receding horizon controller. Similarly, performance improves as initial pretension of the robot increases, before dropping off. Intuitively, these results match expectations, as greater stiffness creates less oscillatory dynamics which the controller is unable to account for, due to the low controller timestep of 0.01 seconds. Greater stiffness and pretension ensures that the robot is less likely to drastically deform in a detrimental manner by giving immediate and precise control over the state of the robot with less actuation input. That said, the results illustrate that excessively large pretensions can also negatively affect tensegrity locomotion. One possible explanation for this observed behavior is that excessively large pretensions during the initial state require more actuation before the robot can sufficiently change its shape and enter a stable dynamic rolling gait.

Effectively, these results support that tensegrity robots become easier to control using inexpensive and computationally-limited microcontrollers as the tensegrity dynamics approach rigid-like behavior; lower update frequencies are less of an issue as state uncertainty due to compliance in the robot decreases. Unfortunately, greater stiffness in the overall robot also leads to prohibitively high torque and power requirements on the motor actuators, an issue discussed in greater detail below.

Speed and Directional Control

Next, the performance of the three actuation schema presented earlier (i.e., 6-motor, 24-motor fully-actuated, and 12-motor paired-actuated) is compared with respect to average rolling speed and directional trajectory control. In this section, the advantages that are provided through the use of additional cable actuators are discussed.

As an illustrative example, the average rolling speed of the robot under each of the three actuation policies is examined, maximizing rolling velocity in a specified direction. To get a more representative average speed, the total number of timesteps that are simulated is doubled from the previous section.

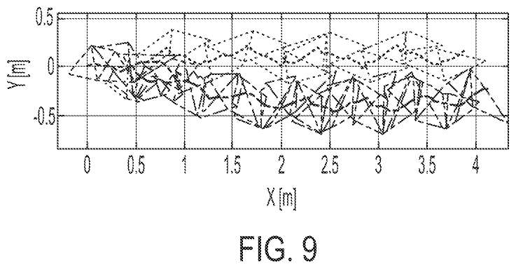

FIG. 9 illustrates footprint trails of the robot starting at the origin and rolling in the +X-direction for 10 seconds using 24-motor fully-actuated (red), 12-motor paired-actuated (green), and 6-motor actuation policies (blue). Solid lines indicate the robot's center of mass and dotted lines indicate supporting polygons in contact with the ground.

From the trials shown in FIG. 9, it is clear that the greater control authority, afforded by more actuated cables for 24-cable policies, enables the robot to accomplish locomotion tasks that the 6-motor variant simply cannot complete. In this simple illustrative example, it is apparent that, given the limited degrees of freedom, the 6-motor actuation scheme is simply unable to roll in the desired direction and becomes stuck as it attempts to do so. That said, both the fully-actuated and paired-actuated 24-cable policies were able to perform reasonably well. Naturally, however, the greater controllability of the fully-actuated system allows for greater directional trajectory-tracking accuracy along the +X-axis.

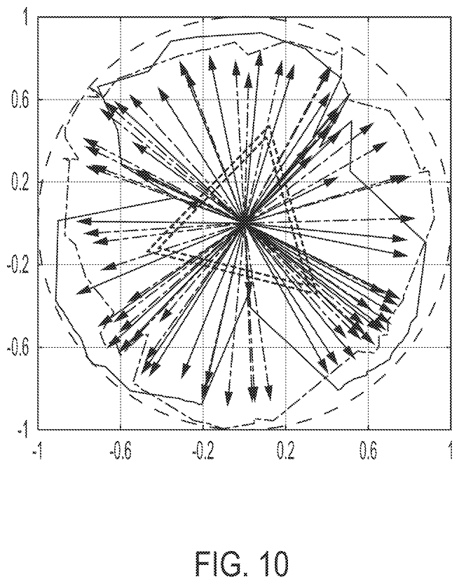

FIG. 10 is a plot showing normalized average speeds in various directions, starting from an identical initial state (base polygon outlined in dashed black lines). Red represents results for fully-actuated 24-motor scheme, and blue represents 12-motor paired-cable actuation scheme.

In FIG. 10, this improved directional controllability is highlighted as the robot's performance is evaluated in any-direction rolling. In this figure, average rolling speeds are normalized by the fastest experimental trial, so that all arrows lie within the unit circle. In particular, it is shown that while both the 24-motor and 12-motor schema can achieve reasonable top speeds, the lesser degree of freedom provided by the paired-cable schema (i.e., 12 motor actuators rather than 24), precludes good performance in all directions.

To conclude, the relative performance of each actuation policy is summarized in Table 4, stating the average speeds of each scheme followed by a normalized value—average speed divided by the product of the rod length of the spherical tensegrity design and the maximum linear velocity of the motors.

Importantly, this normalization will simplify comparisons of performance across different hardware configurations and tensegrity topologies.

TABLE 4

| Schema | 6-motor | 12-motor | 24-motor |
|---|---|---|---|
| Avg. Speed | 18.1 cm/s | 37.9 cm/s | 38.2 cm/s |
| Norm. Speed | 1.51e−02 | 3.16e−02 | 3.18e−02 |

Energy Efficiency

This final section briefly discusses the energy efficiency of both the 12-motor paired-cable and 24-motor actuation schema. As shown in the previous section, comparable performance for maximum rolling speeds is achieved for both 12-motor and 24-motor actuation schemes. However, as demonstrated, 12-motor actuation does sacrifice some degree of maneuverability due to the lesser control authority granted. Nevertheless, in this section, a compelling motivator is provided for the 12-motor variant on the basis of energy efficiency.

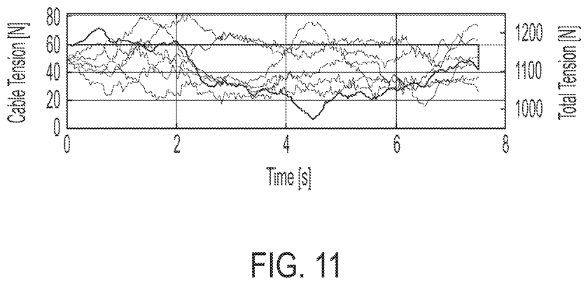

A simplified model of energy-costs is considered which relates tension in the robot to power consumed by the motors. Specifically, cable tensions (see FIG. 11) are directly related to load torques on the motor and correlates to current draw and power consumption. FIG. 11 shows cable tensions for 6 of 24 cables (left) and total tension (right) for 24-motor rolling locomotion. Note, in attaining maximum rolling speed, total tension in the robot remains below the initial pretensioned state after some time (2 seconds).

If 65% efficient motors are assumed, the average Cost of Transport (i.e., energy divided by mass times distance traveled) over 100 trials are 159.9 and 30.7 for 24-motor and 12-motor actuation schema, respectively. Notably, the exceptional Cost of Transport is on par with the locomotive efficiency of many animals found in nature [13]. Specifically, the unique paired-cable mechanism is able to leverage complementary tensions of each cable-pair such that the motor does minimal work under normal operating conditions. Thus, while some degree of maneuverability is lost, the energy efficiency gains makes a 12-motor paired-cable actuation schema an enticing candidate tensegrity robot design.

Conclusion

In conclusion, a novel 12-motor paired-cable actuation policy is introduced with the practical benefits it holds over the more complex, fully-actuated 24-motor configuration. In formulating the point mass dynamics and simulating the optimal MPC state-action trajectories for the 6-motor, 12-motor, and 24-motor actuation policies, the relative performances of each scheme were evaluated. As an insightful result, it was demonstrated that the new 12-motor paired-cable scheme is capable of competitive rolling speeds and is over five times more energy efficient than the other two configurations; however, since the 24-motor scheme has greater control authority, it has better directional trajectory-tracking than both the 6-motor and 12-motor variants. Finally, these tools can be used to investigate even more novel tensegrity topologies and to apply the new paired-cable actuation policy on new robot hardware for empirical results.

Custom Tensegrity Simulation Framework

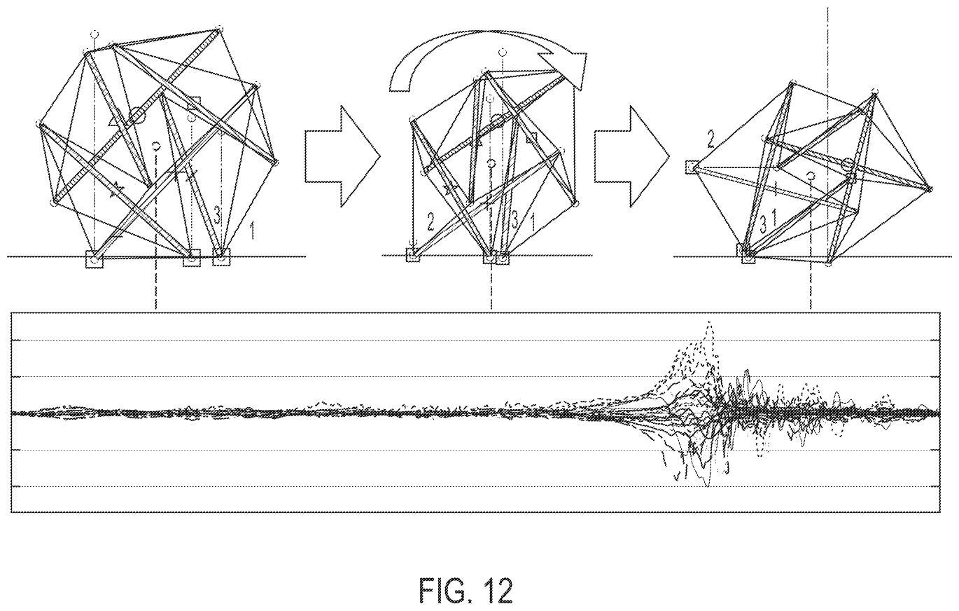

According to some embodiments of the invention, a custom-designed simulation environment was developed in MATLAB for simulation of the tensegrity robot and easy interfacing with existing optimization toolboxes. FIG. 12 shows a MATLAB simulation of six-bar spherical tensegrity rolling using 24-cable actuation, at rest (left), initial tipping instability (middle), and impact on the next base (right). Bottom: Corresponding linear velocities [m/s] and angular velocities [rad/s] of all rods (30-dimensional velocity vector).

Using the dynamics described above, a framework for simulation of the robot was created, to be a general-purpose tool for simulation and motion planning of any Class-1 tensegrity system. Due to the structured nature of the tensegrity dynamics, as discussed in section previous sections, construction of idealized models for Class-1 topologies is relatively straightforward. However, during development, several key insights were made evident, and additional features in the simulation were incrementally added as needs progressed. What began as a simple simulation of a free-floating tensegrity in the absence of gravity has evolved into a relatively comprehensive simulation environment for tensegrities in contact-rich dynamics. The work-in-progress Github repository can be found at: github.com/brianmcera/Tensegrity-Dynamics-and-Optimal-Control.

Modular Object-Oriented Approach

The primary motivation for creating this simulation environment is to enable rapid proto-typing of different controllers, estimators, and motion planning techniques without the need to operate on experimental hardware. Additionally, this simulation environment allows for iterative testing of different hardware designs and tensegrity topologies, such as adjusting motor capabilities, sensor placement, component specifications, etc. Tensegrity hardware, with their many actuators and complex mechanical designs, are currently a challenging platform to work with. To improve research and development with tensegrity hardware in the loop, many advances must be achieved in terms of reliability and ease-of-use. In the meantime, this simulation framework has proven to be an invaluable software tool for evaluating novel approaches and exploring different research topics in tensegrity robotics.

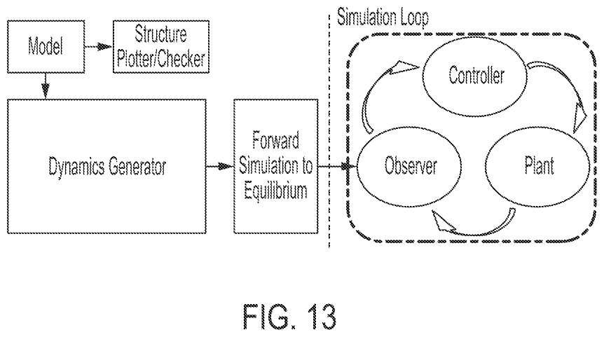

To facilitate the evaluation of different interconnected components, careful consideration was given to ensure that a modular design paradigm was consistent throughout the simulation framework. It became evident early on that having a monolithic coding design which combined all aspects of the robot's dynamics, controls, and state estimation would not enable quick evaluation of different design trade-offs (e.g., using a specific controller approach such as MPC for a specific tensegrity design would require completely separate code than a tensegrity spine robot using differential dynamic programming). Instead, we adopt an object-oriented approach which isolates individual components of the simulation loop outlined in FIG. 13. A high-level API guarantees that these components can interact with one another in a universal manner, meaning that different controllers can be easily combined with different observers to control any variety of tensegrity dynamics models.

Automatic Generation of Dynamics Equations

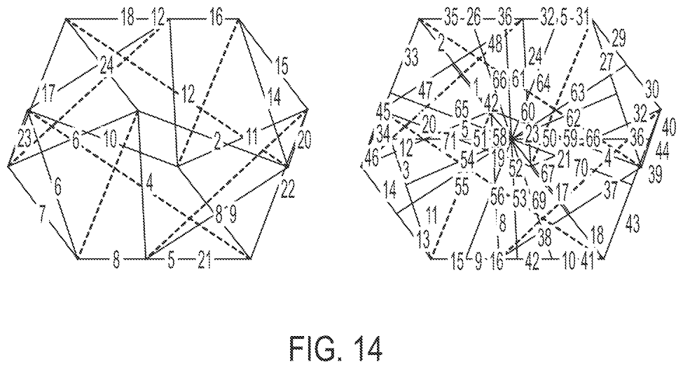

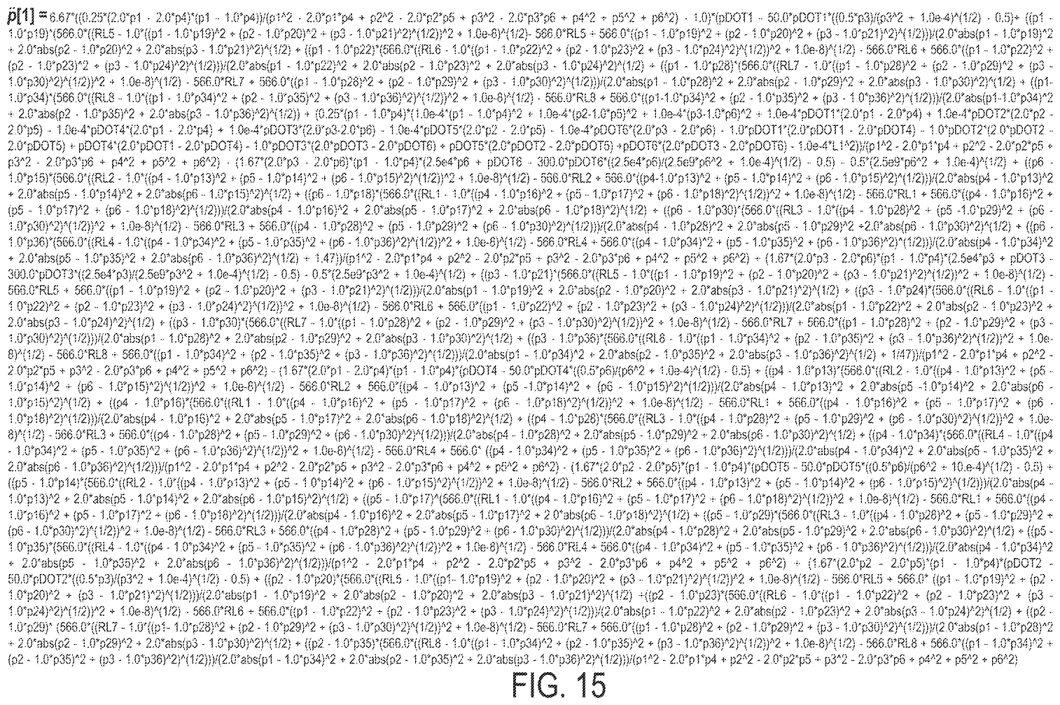

The primary powerhouse of this simulation environment is the automated symbolic dynamics generator (represented in navy blue in FIG. 13) which enables quick calculation of the dynamic equations of motion for any Class-1 tensegrity system. In contrast to previous work in the lab, which required hand-calculation or numerical approximation of linearized dynamics for model-based approaches, this framework produces differentially smooth dynamics equations (see FIG. 14 and FIG. 15) and analytically-obtained symbolic Jacobian matrices. Due to the continuously differentiable equations of motion and simple-to-obtain analytical Jacobian matrices, this dynamics formulation enables us to quickly prototype different controllers and state estimators which rely on smooth assumptions and linearized approximations.

FIG. 14 shows two different types of Class-1 spherical tensegrities. Rods are depicted in magenta; cables are shown in black and numbered in blue. Despite the difference in number of cables and connection locations, contact-rich dynamic equations of motions can be generated for both on the fly. The canonical 6-bar spherical tensegrity is shown in (a), and a spherical tensegrity with central-payload suspended by an additional 24 internal cables is shown in (b).

FIG. 15 shows an example of a single symbolic equation of motion representing the acceleration of a single node in the positive X-direction. Note the complex dependencies on other states in the system, namely other nodal positions (variables prefixed by ‘p-’), nodal velocities (variables prefixed by ‘pDOT-’), and cable rest lengths (variables prefixed by ‘RL-’).

State Initialization with Kinetic Energy Damping

The need for proper initialization of the robot state was apparent early on in the development of the simulation environment. In the earliest naive approaches, the 6-bar tensegrity was initialized using a regular icosahedron assumption (i.e., rods and nodal positions were defined assuming the outer surface of the spherical tensegrity had equilateral triangles for each of its 20 faces). In practice, this initialization did not work for two reasons—early implementations of the code either: 1) did not take initial desired pretension into account (so that the robot would immediately collapse) or 2) didn't account for drastic transient effects that occurred once the robot was initialized and released from the initial state. Specifically, if cable rest lengths were immediately set by a desired pretension rather than incrementally updated, excessively large accelerations caused the simulation to be unstable, regardless of timestep size. Additionally, these large accelerations made it difficult for the model-based controllers to initially find optimal input sequences, as the early dynamics of the robots were dominated by the erroneous effects described above.

To address this, simulations now begin by first finding nominal states, using the regular-icosahedron assumption described above, and then forward simulating the dynamics until equilibrium (depicted by the purple block in FIG. 13). Nominal nodal separation distances are first calculated, then a desired pretension determines the appropriate cable rest length set points relative to these initial distances. In contrast to the naive approach above, cables are gradually controlled to these rest lengths rather than immediately set, to mitigate excessively large forces and accelerations. To speed up this initialization, energy of the system is observed at each time step and kinetic energy damping is employed (i.e., nodal velocities are set to zero each time kinetic energy of the system peaks). This artificial damping is not representative of the true dynamics of the system but offers a drastic reduction in the number of computation iterations necessary during initialization to reach equilibrium.

Example Applications for Design Analyses

The simulation framework above allows us to rapidly prototype various experimental tensegrity designs and topologies, through faster brainstorming and ideation workflows than is possible with empirical hardware tests. While the primary focus of the simulations is to enable the comprehensive evaluation of different software controllers and observers, the simulation environment is also suitable for simple, rudimentary dynamic tests which can provide valuable information for quick mechanical design and trade-off analysis.

Asymmetric Drop Testing

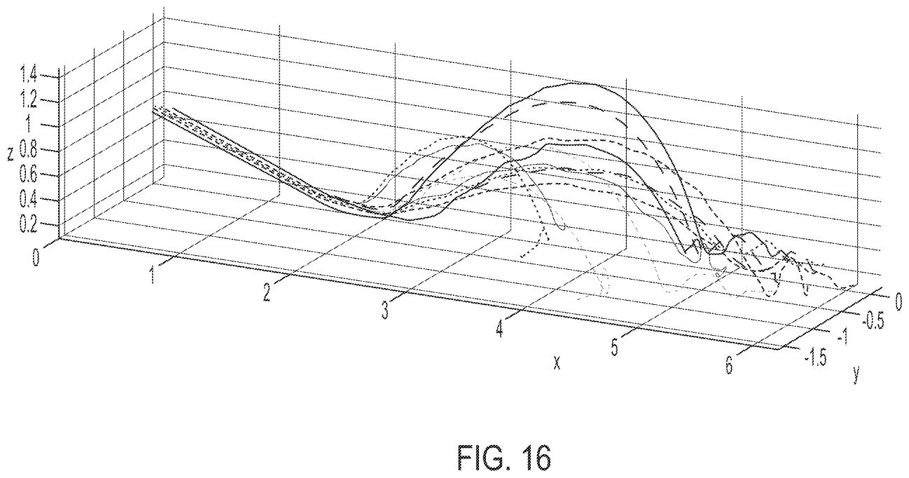

One example application which leverages the symbolic dynamics generator is the evaluation of dynamic effects of asymmetric tensegrity weighting. Namely, through a research grant supported by the US Army, Squishy Robotics would like to investigate the efficacy of using an asymmetric weight distribution on the rod ends to have the tensegrity robot reliably land in a specific orientation and/or location (see FIG. 16).

FIG. 16 illustrates a visualization depicting Monte Carlo simulations of robot center-of-mass trajectory during bouncing, starting from the same position but different initial robot pose rotations. All trajectories start with robot center-of-mass roughly at (0,0,1) with an applied horizontal velocity. Results obtained using the simulation framework described in this chapter demonstrate the dynamics' stochastic nature and dependence on robot orientation upon impact.

Running through different modifications of the tensegrity models would typically require an additional recompilation step if using the C++ NASA NTRT simulation toolkit [14] or extensive computation times with long workflow cycles if using high-fidelity FEA software such as ANSYS. Instead, this low-fidelity framework provides preliminary results to help analyze broad, general trends—taking only a few minutes per trial experiment—which can help motivate design decisions and narrow down an overabundance of design variables to a select few which may warrant further examination using more complex and precise FEA simulation tools.

Center Payload Acceleration Mitigation

Tensegrity structures boast the unique ability to mitigate impact forces using such a lightweight, compact compliant design. As such, many applications of interest are concerned with the tensegrity structure's ability to dissipate forces quickly throughout the entire structure, in order to protect a shock-sensitive payload. High-end FEA tools can provide detailed analysis of the stresses and strains propagated throughout the structure during impact, but a high-fidelity simulation might take dozens hours to complete. Instead, designers may be interested in investigating broad trends for a simple trade-off analysis, comparing competing mechanical design considerations with application goals and design criteria. This simulation framework enables rapid prototyping in simulation to evaluate different tensegrity topologies with various mechanical properties in order to quickly motivate design decisions moving forward and to identify potential modes of failure to analyze in greater detail.

Imitation Learning with Optimal Control Experts

Solving the necessary constrained optimization problems requires significant computation time of up to one-hundredth of a second for every control update. More efficient software implementations could further improve computation time, but still would likely not allow for MPC to be run on a less powerful embedded microcontroller in real-time with readily available hardware. Thus, the compliance of these tensegrities is both a benefit and a burden—the robust physical attributes of these unique systems come hand-in-hand with controller complexity.

Input Remapping and Online Control Using Deep Learning

One approach in some embodiments to addressing the intractability of real-time MPC with tensegrities is to utilize MPC and iLQR methods not as an online control policy but as an offline ‘expert’ reference for supervised imitation learning. In short, imitation learning is a machine learning approach that leverages expert-labeled data of optimal input-action pairs in order to train a policy to mimic expert behavior. Using an imitation learning approach, rather than solve a constrained optimization problem for MPC in real-time, a feedforward neural network trained on optimal state-action trajectories is used to allow for real-time implementation of feedback control. Furthermore, input remapping is leveraged to allow generating a reduced-order mapping by providing full-state information during optimal trajectory generation while only using a subset of the states (e.g., observation information readily available through hardware sensors) for the learning process [15]. Utilizing this approach, these results demonstrate real-time directed spherical tensegrity rolling with multi-cable actuation—i.e., using simultaneous actuation of all 24 cables to achieve rolling locomotion in any arbitrary user-defined direction.

For this work, 150+ trajectories were generated using the MPC approach and used as demonstration trajectories to train a contextual neural network policy which accepts state estimates and a user-defined desired rolling direction. To ensure that the expert trajectories generate a wide support for all user-defined directions, not only was the overall desired direction of the straight-line path randomized, but intermediate corrective directions—provided whenever the robot deviated from the straight-line path—were also recorded for each timestep, greatly increasing the variation of observed commanded directions. Additionally, some data pre-processing was also utilized to add Gaussian noise to the input and to exploit rotational symmetry for the contextual policy.

To help improve the robustness of the policy to model perturbations, it was also ensured that the state-action trajectories that were generated had rod masses which were randomly drawn from a uniform distribution with nominal mean of 1.1 kg and spread of +/−10%. This parameter variation approach helps the policy better generalize and reduces the effects of discrepancies between the simulation source domain and hardware target domain.

A contextual deep neural network policy with two hidden layers of 100 nodes each and hyperbolic tangent sigmoid activation function was trained to map a reduced-order input vector, X∈R⁴⁴, to a discrete action vector, U∈R²⁴.

Specifically, the input was a concatenation of: 1) rod orientations (represented through functions of spherical coordinates), 2) cable restlength deviations from the neutral pose, and 3) a contextual input of x, y coordinates corresponding to a desired rolling direction. Each action Uᵢ∈{−1, 0, 1} corresponds to a max velocity retraction, hold and maintain restlength, or max velocity release command, respectively, to one of the 24 actuated cables. In practice, this discretization of the continuous action space helped speed up learning time and improve sample-efficiency. To ensure that cable restlengths remained in a reasonable range, hard limits for minimum and maximum allowable lengths were set, helping prevent the robot from unreasonably de-tensioning and collapsing or tensioning to dangerous levels.

From the results, it was found that the neural network policy trained using simple supervised learning successfully captured the general patterns of optimal MPC state-action trajectories to allow the robot to locomote when starting from arbitrary poses, even with only partial observability. Although cable rest length commands often reached the upper and lower permissible limits (likely due to the discrete action space with maximum velocity extension or retraction), the simulated robot was able to perform dynamic rolling motions in directions that could be updated in real-time, starting from different initial conditions.

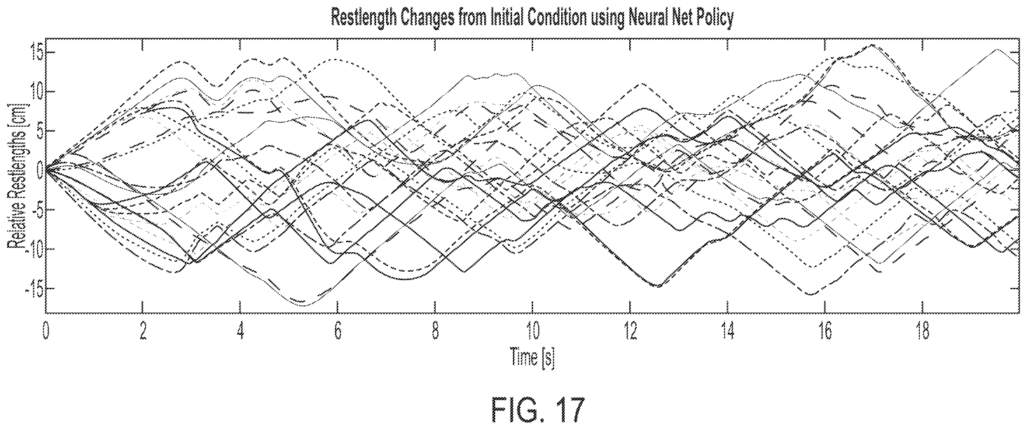

FIG. 17 shows controlled cable rest lengths from a contextual neural network policy trained using imitation learning. Note the smoother transitions for cable actuation as compared to that of trajectories generated using MPC (as illustrated in FIG. 5).

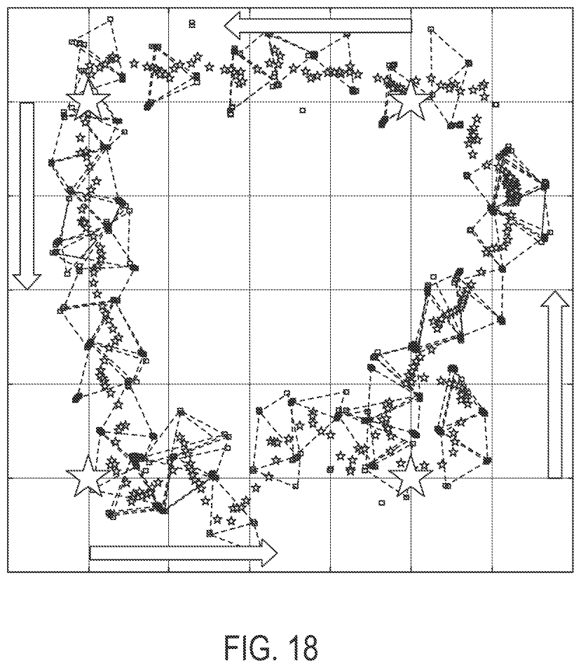

As a simple example, desired directions were given to command the robot to roll in a square trajectory from different initial conditions (see FIG. 18). Though optimality guaran-tees are no longer provided, using a deep neural network trained with supervised machine learning on simulated ‘expert’ MPC trajectories is a relatively simple, sample-efficient ap-proach for effective real-time feedback control of complex, compliant tensegrity systems.

FIG. 18 shows rolling locomotion in a square trajectory controlled using a contextual policy trained through supervised learning. Green stars are waypoint destinations. Red points are the CoM over time. Blue outlines are the supporting base polygons of the robot and black squares signify nodal contact with the ground.

Robust Nonlinear Trajectories with Minimax Iterative Dynamic Games

The optimization-based techniques described above enable quickly generating optimal actuation policies for any desired tensegrity behavior for which a representative reward/cost function can be defined for. One weakness of the model-based approaches presented previously, however, is their dependency on accurate dynamics models in generating optimal motion planning trajectories. Any disparity, uncertainty, or model mismatch leads to inaccuracies when using an incorrect nominal model to predict behavior over longer time horizons. This brittleness limits their application in practical use cases where nominal models may be difficult to obtain or subject to uncertainty. In the context of flexible mobile robotics such as tensegrities, this uncertainty is further compounded with discontinuous nonlinearities that are present in contact-rich rolling locomotion.

Robust Minimax Control Combined with State Estimation

As alluded to above, tensegrity robotics face an especially difficult challenge for motion planning and trajectory optimization due to the uncertainties which naturally arise as a result of compliance throughout the system in addition to noisy sensor measurements and imperfect models. Physical characteristics and material properties of the robot may vary significantly from model parameters solely due to manufacturing and assembly tolerances. Additionally, sensor fusion and optimal estimation approaches address sensor noise to a degree, but pragmatic applications of these control policies must be able to handle imperfect state estimates. In this section, the performance of the previously described minimax controller is assessed in combination with state estimation in order to better understand performance capabilities of the robot in a more challenging context with imperfect information.

To this end, experiments were simulated applying a robust minimax iDG method that expands upon the original motion planning approaches and have demonstrated successful results. The results show that this robust control formulation enables successful rolling locomotion with adversarial disturbances/noise of up to 10% of the maximum control input magnitude (i.e., 1 cm/s control authority for the adversarial agent). More importantly, this ability to handle adversarial perturbations directly leads to being capable of continuous dynamic rolling even when given noisy imperfect state estimates. Using the same physical model parameters as outlined in Table 2 above, and sensor noise characteristics as outlined in Table 5, the robust minimax iDG approach was applied to a simulated robot with state estimation implemented using an Unscented Kalman Filter (UKF).

TABLE 5

| Sensor Measurement | Standard Deviation |
|---|---|
| Rod Orientation | ± 5 degrees |
| Cable Rest Length | ± 5 cm |
| Nodal Velocity | ± 1 m/s |

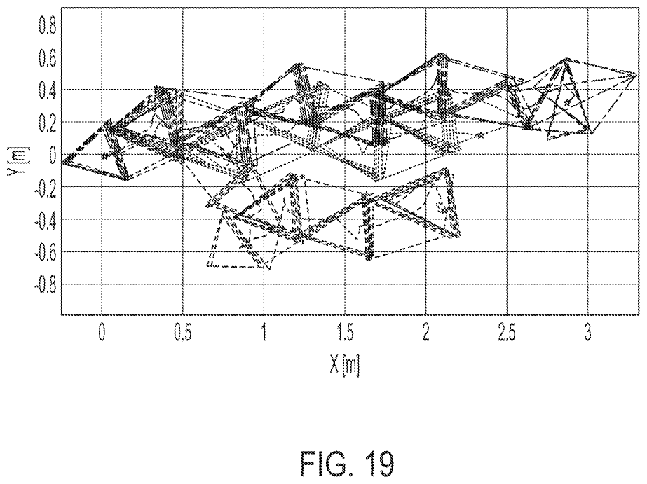

FIG. 19 shows a comparison of rolling performance with/without state estimation and robust minimax motion planning. The three cases depicted are: perfect full state information with nominal iLQR controller (blue); noisy state estimates with UKF and nominal iLQR controller (green); noisy state estimates with UKF and robust minimax iDG controller (red). Note that the minimax controller does a better job at tracking the desired trajectory in the positive X direction, as compared to the nominal controller.

From the results shown in FIG. 19, we illustrate that the robust controller is significantly better at handling noisy state estimates, nearly matching the nominal performance of the iLQR controller with perfect full-state information, albeit at a slower conservative speed. In contrast, the nominal controller struggles to contend with noisy measurements (shown in green) and occasionally suffers from unexpected transitions in an undesired direction. One potential reason for this type of failure is the unique method of moving the tensegrity robot center of mass to force an unstable transition from one face to another. Inaccuracies in the shape of the supporting base polygon, the robot contact interactions with the ground, the pose of the robot, or any other multitude of factors may lead the robot into taking an action which it falsely believes is beneficial. In reality, inaccuracies cause the robot behavior to evolve in an unanticipated manner, and once the robot is placed in a precarious unstable state, the punctuated rolling motion continues through, with no means of control authority to stop. Thus, while the minimax formulation is suboptimal in terms of purely rolling speed, this approach may be one way to address real-world uncertainty with rolling tensegrity robots.

### REFERENCES

[1] V. SunSpiral, A. Agogino, and D. Atkinson, “Super ball bot-structures for planetary landing and exploration, niac phase 2 final report,” 2015.
[2] K. Kim, A. K. Agogino, D. Moon, L. Taneja, A. Toghyan, B. De-hghani, V. SunSpiral, and A. M. Agogino, “Rapid prototyping design and control of tensegrity soft robot for locomotion,” in 2014 IEEE International Conference on Robotics and Biomimetics (ROBIO 2014). IEEE, 2014, pp. 7-14.
[3] L.-H. Chen, B. Cera, E. L. Zhu, R. Edmunds, F. Rice, A. Bronars, E. Tang, S. R. Malekshahi, O. Romero, A. K. Agogino et al., “Inclined surface locomotion strategies for spherical tensegrity robots,” in 2017 IEEE/RSJ International Conference on Intelligent Robots and Systems (IROS). IEEE, 2017, pp. 4976-4981.
[4] K. Kim, A. K. Agogino, A. Toghyan, D. Moon, L. Taneja, and A. M. Agogino, “Robust learning of tensegrity robot control for locomotion through form-finding,” in 2015 IEEE/RSJ International Conference on Intelligent Robots and Systems (IROS). IEEE, 2015, pp. 5824-5831.
[5] C. Paul, F. J. Valero-Cuevas, and H. Lipson, “Design and control of tensegrity robots for locomotion,” IEEE Transactions on Robotics, vol. 22, no. 5, pp. 944-957,2006.
[6] M. Zhang, X. Geng, J. Bruce, K. Caluwaerts, M. Vespignani, V. Sun-Spiral, P. Abbeel, and S. Levine, “Deep reinforcement learning for tensegrity robot locomotion,” in 2017 IEEE International Conference on Robotics and Automation (ICRA). IEEE, 2017, pp. 634-641.
[7] J. Luo, R. Edmunds, F. Rice, and A. M. Agogino, “Tensegrity robot locomotion under limited sensory inputs via deep reinforcement learning,” in 2018 IEEE International Conference on Robotics and Automation (ICRA). IEEE, 2018, pp. 6260-6267.
[8] B. Cera and A. M. Agogino, “Multi-cable rolling locomotion with spherical tensegrities using model predictive control and deep learning,” in 2018 IEEE/RSJ International Conference on Intelligent Robots and Systems (IROS). IEEE, 2018, pp. 1-9.
[9] A. Witkin, “Physically based modeling—constraint dynamics,” ACM SIGGRAPH 2001 Course Notes, 2001.
[10] C. E. Garcia, D. M. Prett, and M. Morari, “Model predictive control: theory and practicea survey,” Automatica, vol. 25, no. 3, pp. 335-348, 1989.
[11] J. B. Rawlings and D. Q. Mayne, Model predictive control: Theory and design. Nob Hill Pub. Madison, Wis., 2009.
[12] J. Löfberg, “Yalmip: A toolbox for modeling and optimization in matlab,” in Proceedings of the CACSD Conference, vol. 3. Taipei, Taiwan, 2004.
[13] R. J. Full and M. S. Tu, “Mechanics of a rapid running insect: two-, four- and six-legged locomotion,” Journal of Experimental Biology, vol. 156, no. 1, pp. 215-231, 1991.
[14] J. Bruce, K. Caluwaerts, A. Iscen, A. P. Sabelhaus, and V. SunSpiral. “Design and evolution of a modular tensegrity robot platform”. In: 2014 IEEE International Con-ference on Robotics and Automation (ICRA). May 2014, pp. 3483-3489. DOT: 10. 1109/ICRA.2014.6907361.
[15] Sergey Levine, Chelsea Finn, Trevor Darrell, and Pieter Abbeel. “End-to-end training of deep visuomotor policies”. In: The Journal of Machine Learning Research 17.1 (2016), pp. 1334-1373.

1. A tensegrity robot, comprising:
a plurality of structural members;
a plurality of tensile members connected to said plurality of structural members to form a spatially defined structure such that each structural member is connected to one or more other structural members by one or more of said plurality of tensile members therebetween;
a plurality of actuators operatively connected to said plurality of tensile members and said plurality of structural members; and
a plurality of controllers configured to communicate with each of said plurality of actuators,
wherein said plurality of controllers direct control of at least one of tension or length of said plurality of tensile members by said plurality of actuators so as to cause at least one of a change in size, shape or center of gravity of said spatially defined structure to effect robotic actions, and
wherein at least two tensile members are connected to one actuator such that at least one of tension or length in both of said at least two tensile members are changed in coordination by said one actuator.

2. The tensegrity robot according to claim 1, wherein each of said plurality of structural members is an elongated generally cylindrical tube-like or rod structure.

3. The tensegrity robot according to claim 1, wherein each of said plurality of tensile members are at least one of bungee cords, elastic bands, or nylon cables with springs.

4. The tensegrity robot according to claim 1, wherein said one actuator is a motor comprising a pair of spools arranged such that one said plurality of tensile members can be wound tighter while another of said plurality of tensile members can be unwound to loosen at the same time with the same rotation of the pair of spools in unison.

5. The tensegrity robot according to claim 1, wherein at least two of said plurality of actuators are each operatively connected to at least two respective tensile members of said plurality of tensile members.

6. The tensegrity robot according to claim 1, further comprising an onboard data processor connected to said tensegrity robot,
wherein said data processor comprises computer executable code that when executed sends information to said plurality of controllers to perform said robotic actions,
wherein said computer executable code takes into account that at least one actuator acts on at least one pair of tensile members simultaneously.

7. The tensegrity robot according to claim 1, further comprising an external data processor configured to communicate with said tensegrity robot,
wherein said external data processor comprises computer executable code that when executed sends information to said plurality of controllers to perform said robotic actions,
wherein said computer executable code takes into account that at least one actuator acts on at least one pair of tensile members simultaneously.

8. The tensegrity robot according to claim 1, wherein said one actuator is a motor comprising a plurality of spools arranged such that a plurality of tensile members can be wound tighter without loosening other tensile members.

9. The tensegrity robot according to claim 1, wherein said one actuator is a motor comprising a plurality of spools arranged such that a plurality of tensile members can be unwound to loosen without winding other tensile members.

10. A method for computer control of a tensegrity robot, comprising:
receiving, by a computer, data from a plurality of sensors from said tensegrity robot, said data comprising at least one of tension or length of a plurality of tensile members connected to a plurality of structural members to form a spatially defined structure such that each structural member is connected to one or more other structural members by one or more of said plurality of tensile members therebetween;
computing, based on the received sensor data, a locomotion strategy for the tensegrity robot; and
directing, based on the locomotion strategy, at least one of tension or length of said plurality of tensile members by a plurality of actuators operatively connected to said plurality of tensile members and said plurality of structural members, so as to cause at least one of a change in size, shape or center of gravity of said spatially defined structure to effect robotic actions,
wherein at least two tensile members are connected to one actuator such that at least one of tension or length in both of said at least two tensile members are changed in coordination by said one actuator in response to said directing.

11. The method according to claim 10, wherein computing the locomotion strategy for the tensegrity robot comprises computing an optimal locomotion strategy for the tensegrity robot based on the received data.

12. The method according to claim 10, wherein each of said plurality of structural members is an elongated generally cylindrical tube-like or rod structure, wherein each of said plurality of tensile members are at least one of bungee cords, elastic bands, or nylon cables with springs.

13. The method according to claim 10, wherein said one actuator is a motor comprising a pair of spools, the method further comprising rotating the pair of spools in unison to wind one of said plurality of tensile members tighter and unwind to loosen another of said plurality of tensile members at the same time.

14. The method according to claim 10, wherein at least two of said plurality of actuators are each operatively connected to at least two respective tensile members of said plurality of tensile members.

15. The method according to claim 10, wherein said computer is an onboard data processor connected to said tensegrity robot, the method further comprising:
receiving, from an external computer, information defining said robotic actions;
computing said locomotion strategy further based on said received information, said locomotion strategy comprising instructions for each of said plurality of actuators; and
sending said instructions to a plurality of controllers of said tensegrity robot, said plurality of controllers configured to communicate with each of said plurality of actuators,
wherein said instructions take into account that at least one actuator acts on at least one pair of tensile members simultaneously.

16. The method according to claim 10, wherein said computer is an external data processor configured to communicate with said tensegrity robot, the method further comprising:
receiving, from an external computer, information defining said robotic actions;
computing said locomotion strategy further based on said received information, said locomotion strategy comprising instructions for each of said plurality of actuators; and
sending said instructions to a plurality of controllers of said tensegrity robot, said plurality of controllers configured to communicate with each of said plurality of actuators,
wherein said instructions take into account that at least one actuator acts on at least one pair of tensile members simultaneously.

17. The method according to claim 10, wherein said one actuator is a motor comprising a plurality of spools arranged such that a plurality of tensile members can be wound tighter without loosening other tensile members.

18. The method according to claim 10, wherein said one actuator is a motor comprising a plurality of spools arranged such that a plurality of tensile members can be unwound to loosen without winding other tensile members.

19. A non-transitory machine-readable medium storing computer-executable code for computer control of a tensegrity robot, that when executed configures a computer to:
receive, by the computer, data from a plurality of sensors from said tensegrity robot, said data comprising at least one of tension or length of a plurality of tensile members connected to a plurality of structural members to form a spatially defined structure such that each structural member is connected to one or more other structural members by one or more of said plurality of tensile members therebetween;
compute, based on the received data, a locomotion strategy for the tensegrity robot; and
direct, based on the locomotion strategy, at least one of tension or length of said plurality of tensile members by a plurality of actuators operatively connected to said plurality of tensile members and said plurality of structural members, so as to cause at least one of a change in size, shape or center of gravity of said spatially defined structure to effect robotic actions,
wherein at least two tensile members are connected to one actuator such that at least one of tension or length in both of said at least two tensile members are changed in coordination by said one actuator in response to said directing.

20. The non-transitory machine-readable medium according to claim 19, wherein
said computer executable code when executed further configures the computer to compute an optimal locomotion strategy for the tensegrity robot based on the received data.

21. The non-transitory machine-readable medium according to claim 19, wherein each of said plurality of structural members is an elongated generally cylindrical tube-like or rod structure, wherein each of said plurality of tensile members are at least one of bungee cords, elastic bands, or nylon cables with springs.

22. The non-transitory machine-readable medium according to claim 19, wherein said one actuator is a motor comprising a pair of spools, wherein said computer executable code when executed further configures the computer to rotate the pair of spools in unison to wind one of said plurality of tensile members tighter and unwind to loosen another of said plurality of tensile members at the same time.

23. The non-transitory machine-readable medium according to claim 19, wherein at least two of said plurality of actuators are each operatively connected to at least two respective tensile members of said plurality of tensile members.

24. The non-transitory machine-readable medium according to claim 19, wherein said computer is an onboard data processor connected to said tensegrity robot, wherein said computer executable code when executed further configures the computer to:
receive, from an external computer, information defining said robotic actions;
compute said locomotion strategy further based on said received information, said locomotion strategy comprising instructions for each of said plurality of actuators; and
send said instructions to a plurality of controllers of said tensegrity robot, said plurality of controllers configured to communicate with each of said plurality of actuators,
wherein said instructions take into account that at least one actuator acts on at least one pair of tensile members simultaneously.

25. The non-transitory machine-readable medium according to claim 19, wherein said computer is an external data processor configured to communicate with said tensegrity robot, wherein said computer executable code when executed further configures the computer to:
receive, from an external computer, information defining said robotic actions;
compute said locomotion strategy further based on said received information, said locomotion strategy comprising instructions for each of said plurality of actuators; and
send said instructions to a plurality of controllers of said tensegrity robot, said plurality of controllers configured to communicate with each of said plurality of actuators,
wherein said instructions take into account that at least one actuator acts on at least one pair of tensile members simultaneously.

26. The non-transitory machine-readable medium according to claim 19, wherein said one actuator is a motor comprising a plurality of spools, wherein said computer executable code when executed further configures the computer to rotate the pair of spools such that a plurality of tensile members can be wound tighter without loosening other tensile members.

27. The non-transitory machine-readable medium according to claim 19, wherein said one actuator is a motor comprising a plurality of spools, wherein said computer executable code when executed further configures the computer to rotate the pair of spools such that a plurality of tensile members can be unwound to loosen without winding other tensile members.
